(19) United States
(12) Patent Application Publication
(10) Pub. No.: US 2026/0277208 A1
(43) Pub. Date: Sep. 17, 2026

(54) VEHICLE CONTROL TIME DELAY COMPENSATION

(71) Applicant: Motional AD LLC, Boston, MA (US)

(72) Inventors: Yiming Zhang, Pittsburgh, PA (US); Ludong SUN, Pittsburgh, PA (US); Ahmed El Shaer, Boston, MA (US)

(21) Appl. No.: 19/677,308

(22) Filed: May 14, 2026

Related U.S. Application Data
(63) Continuation of application No. 17/526,195, filed on Nov. 15, 2021, now abandoned.

(51) Int. Cl. G05D 1/221

(52) U.S. Cl. CPC G05D 1/221

(57) ABSTRACT

Provided are systems and methods for vehicle control time delay compensation. Data associated with a vehicle state of the vehicle is provided. Data associated with at least one control parameter is received from the control system, the data generated by the control system based on the vehicle state. A time delay related to generation of the data associated with the at least one control parameter is determined by the control system, the time delay associated with a period of time from when the data associated with the vehicle state was transmitted to the control system to when the data associated with the at least one control parameter was received by the DBW system. A DBW parameter is determined based on the data associated with the at least one control parameter and the time delay, wherein the DBW parameter is used for traversal of a path by the vehicle.

### CROSS-REFERENCE TO RELATED APPLICATIONS

This application is a continuation of U.S. Application Serial No. 17/526,195, filed November 15, 2021, now pending, which is incorporated by reference in its entirety.

### BACKGROUND

A drive-by-wire (DBW) system of a vehicle will receive at least one control parameter related to traversal of a path from a control system of the autonomous vehicle (AV) stack, and then generate one or more DBW parameters to follow that path. However, the provided control parameters are generated by the control system based on the location of the vehicle at the time the control system starts its computation. By the time the control parameters are provided to the DBW system, the vehicle will have moved away from its original location, where the control parameter assumes the vehicle is located.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4 is a diagram of certain components of an autonomous system.

FIGS. 5A and 5B depict diagrams of navigation of a vehicle along a path.

FIGS. 6A–6F are diagrams of an implementation of a process for vehicle control time delay compensation.

FIG. 7 is a flowchart of a process for vehicle control time delay compensation.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a technique that includes providing, by a DBW system of a vehicle to the control system of the vehicle, data associated with a vehicle state. The technique further includes receiving, by the DBW system, data associated with at least one control parameter from the control system, the data generated by the control system based on the vehicle state. The technique further includes determining, by the DBW system, a time delay related to generation of the data associated with the at least one control parameter by the control system, the time delay associated with a period of time from when the data associated with the vehicle state was transmitted to the control system to when the data associated with the at least one control parameter was received by the DBW system. The technique further includes determining, by the DBW system, a DBW parameter based on the data associated with the at least one control parameter and the time delay, wherein the DBW parameter is used for traversal of the path by the vehicle.

More generally, a vehicle (such as an autonomous vehicle) compensates for time delay caused when computing a path of travel for the vehicle. Time delay can be introduced when multiple systems of the vehicle participate in the computation. One such system is a control system that is responsible for identifying control parameters associated with traversal of a path that the autonomous vehicle is to take. Another such control system is the drive-by-wire (DBW) system that causes the vehicle to traverse the path in accordance with control parameters provided by the control system. The time delay error occurs because the DBW system typically provides one or more vehicle-state parameters to the control system, which then calculates updated control parameters associated with traversal of the path and provides the updated control parameters to the DBW system. However, the calculation takes a non-zero amount of time, during which the vehicle will continue to traverse the path based on the previously-provided control parameters, thus introducing error.

By virtue of the implementation of systems, methods, and computer program products described herein, techniques for vehicle control time delay compensation provide a number of advantages. Some of the advantages of these techniques include more accurate traversal of the path by the autonomous vehicle. As noted above, during computation of updated control parameters based on vehicle state, the vehicle will further traverse along the path in accordance with the previous control parameters. As such, when updated control parameters are received, then the vehicle will not be at the same location that it was when computation of the updated parameters began. This traversal will introduce a deviation to traversal of the path based on the movement of the vehicle during the computation. By compensating for the time delay caused by the computation of the updated control parameters, the DBW system is able to identify, and compensate for, the deviations from the intended path.

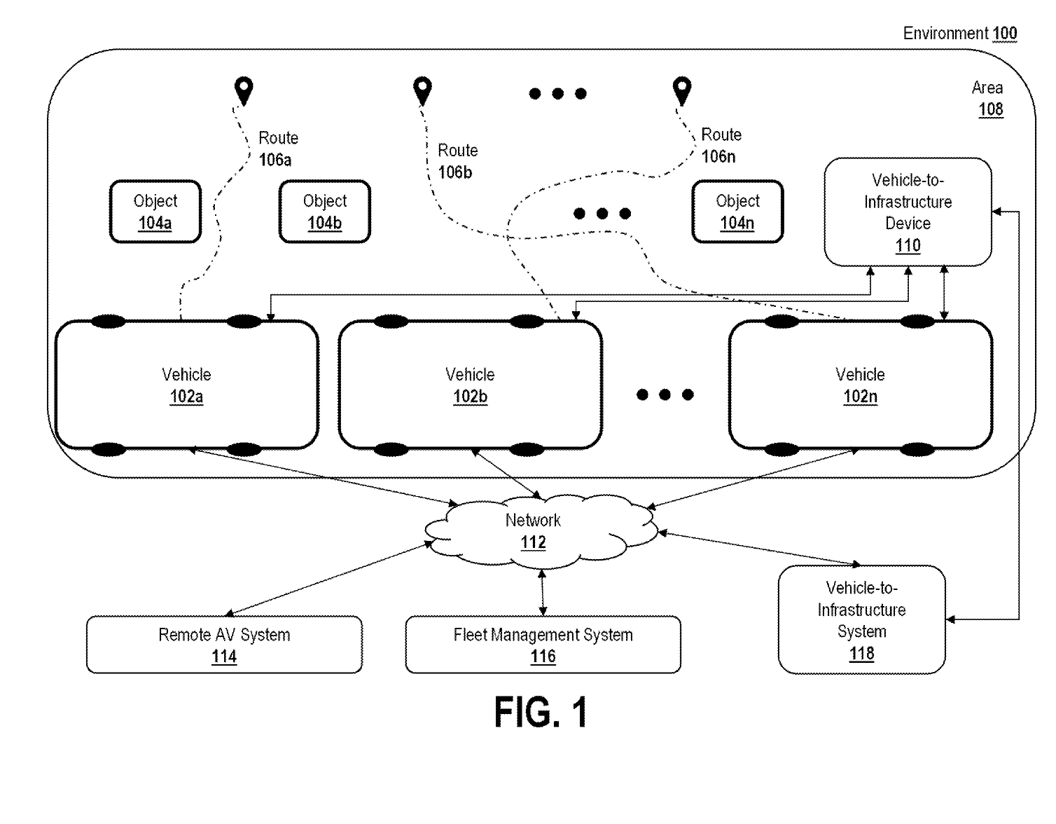

Referring now to FIG. 1, illustrated is example environment 100 in which vehicles that include autonomous systems, as well as vehicles that do not, are operated. As illustrated, environment 100 includes vehicles 102a–102n, objects 104a–104n, routes 106a–106n, area 108, vehicle-to-infrastructure (V2I) device 110, network 112, remote autonomous vehicle (AV) system 114, fleet management system 116, and V2I system 118. Vehicles 102a–102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a–104n interconnect with at least one of vehicles 102a–102n, vehicle-to-infrastructure (V2I) device 110, network 112, autonomous vehicle (AV) system 114, fleet management system 116, and V2I system 118 via wired connections, wireless connections, or a combination of wired or wireless connections.

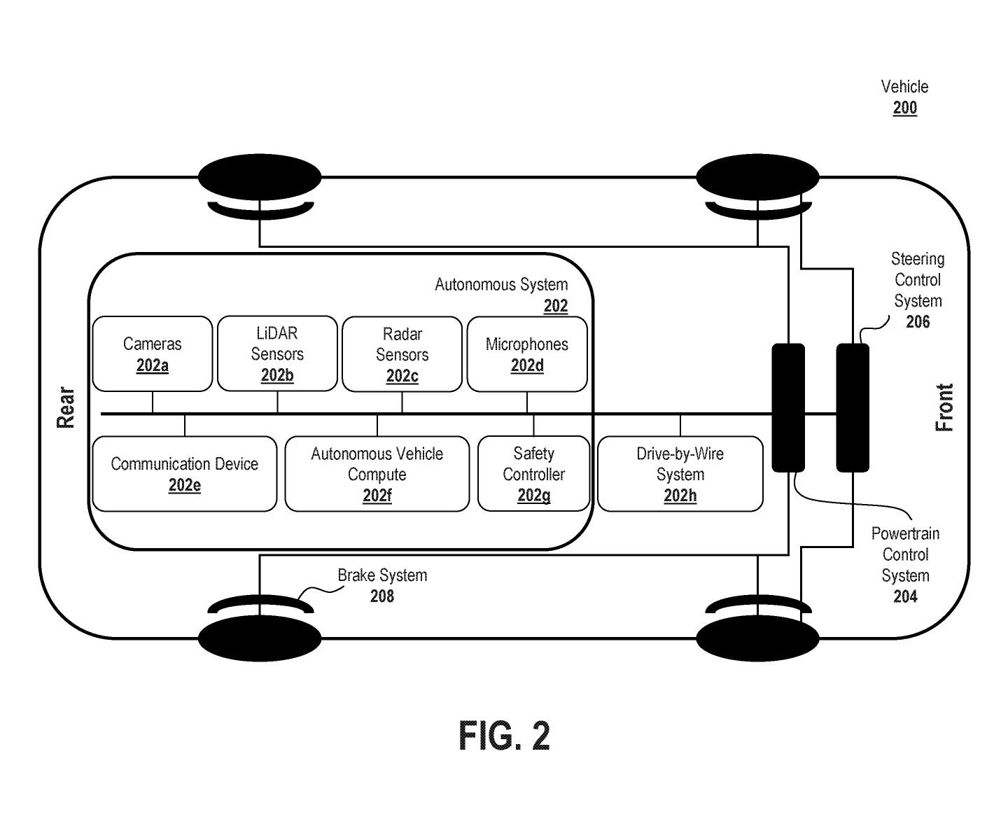

Vehicles 102a–102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a–106n (referred to individually as route 106 and collectively as routes 106), as described herein. In some embodiments, one or more vehicles 102 include an autonomous system (e.g., an autonomous system that is the same as or similar to autonomous system 202).

Objects 104a–104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a–106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

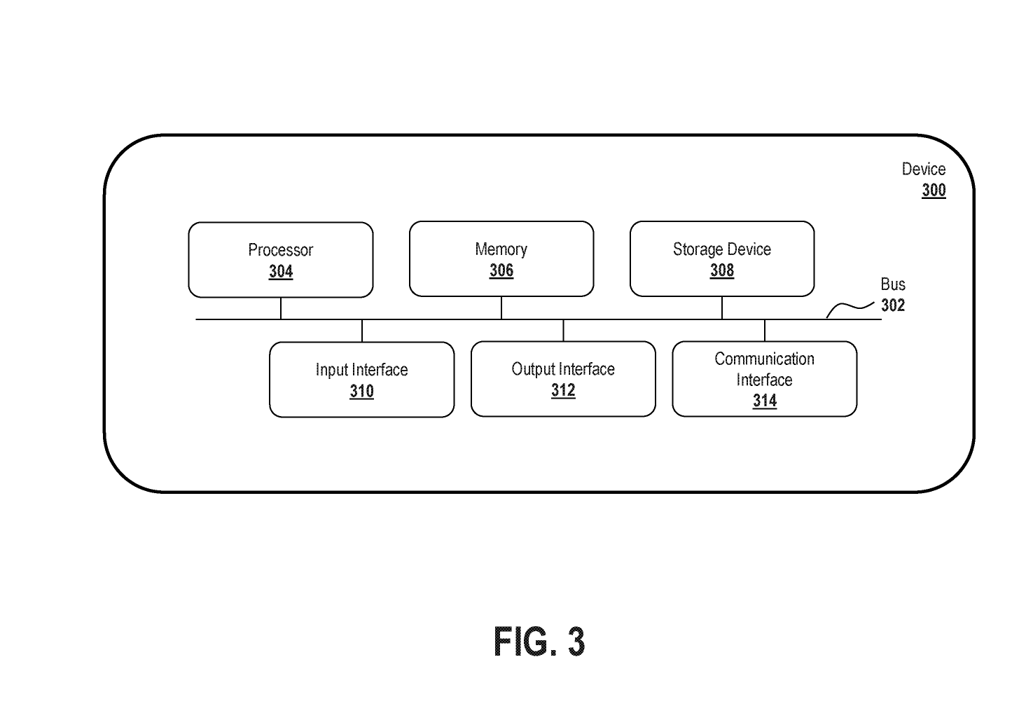

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202agenerates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202cinclude radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202emay include a device that is the same as or similar to communication interface 314 of FIG. 3. In some embodiments, communication device 202eincludes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like).

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of vehicle 200, and/or one or more devices of network 112 (e.g., one or more devices of a system of network 112). In some embodiments, one or more devices of vehicles 102 (e.g., one or more devices of a system of vehicles 102), vehicle 200, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi^{®} interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

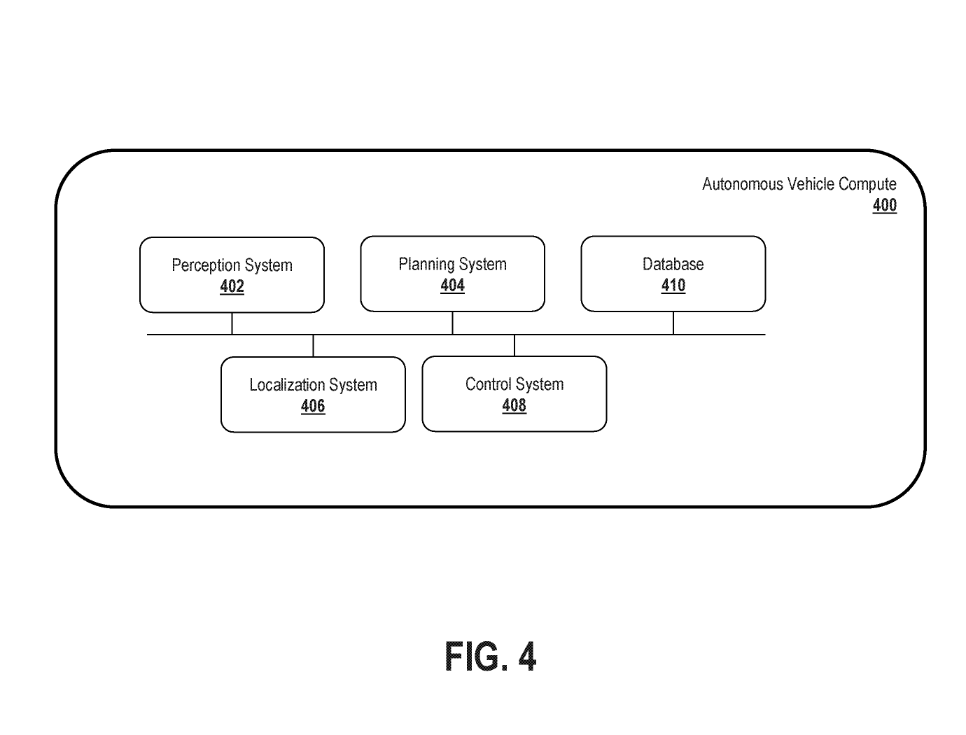

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

As previously noted, embodiments herein relate to time delay compensation. Specifically, embodiments relate to use of a GPS timestamp as a synchronization source. The control system 408 and a DBW system 202h synchronize their internal timers with a GNSS timestamp. When the control system 408 begins a computation related to updated control parameters, one or both of the control system 408 and the DBW system 202h mark the start of the computation with a timestamp. When the computation is finished, the updated control parameters are transmitted to the DBW system 202h. In one environment, the DBW system 202hmarks a timestamp for when it receives the updated control parameters. In another embodiment, the control system 408 generates a timestamp related to when it finished computing the updated control parameters, and transmits the timestamp along with the updated control parameters to the DBW system 202h. When the DBW system 202h receives the updated control parameters, it uses the first timestamp and the second timestamp to calculate a delay related to the control parameters. The DBW system 202h then uses this delay to generate DBW parameters based on the control parameters for use by the vehicle in traversing the path.

As used herein, the term “control parameter” refers to data, information, or a parameter related to control of the vehicle 200 and, more particularly, the DBW system 202h. More generally, a control parameter relates to a parameter of the control system 408. Additionally, as used herein, the term “DBW parameter” refers to data, information, or at least one parameter related to steering, a powertrain, or braking of the vehicle 200, as described above. More generally, a DBW parameter relates to a parameter of the DBW system 202h.

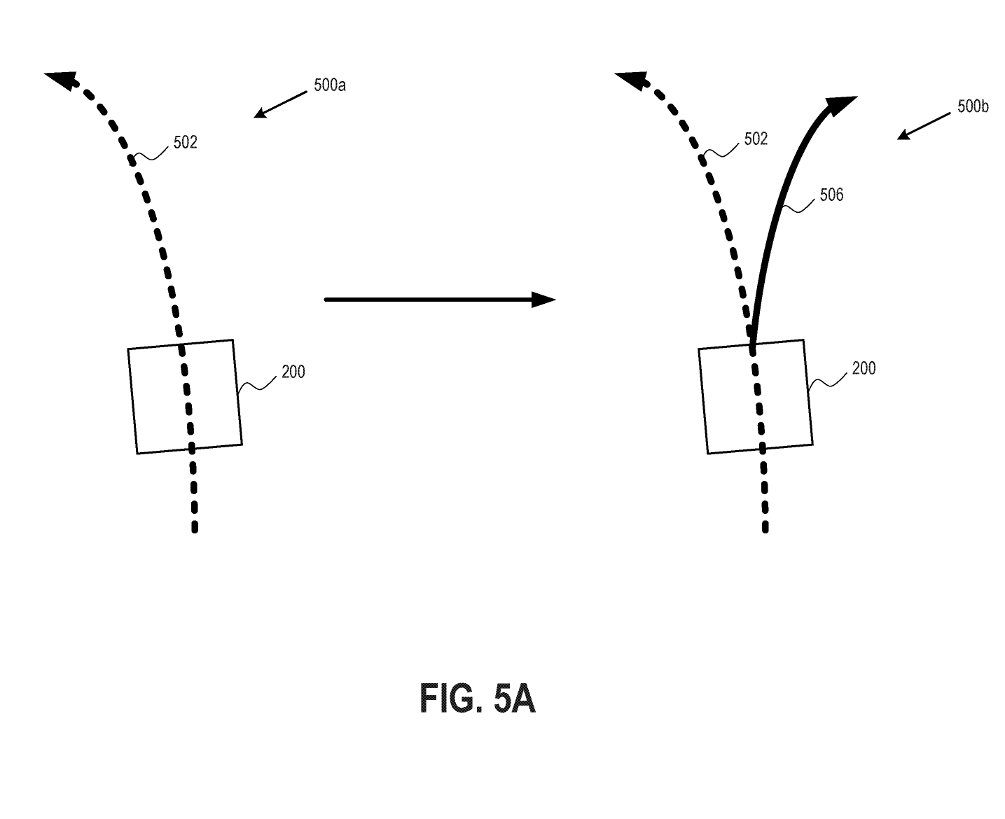

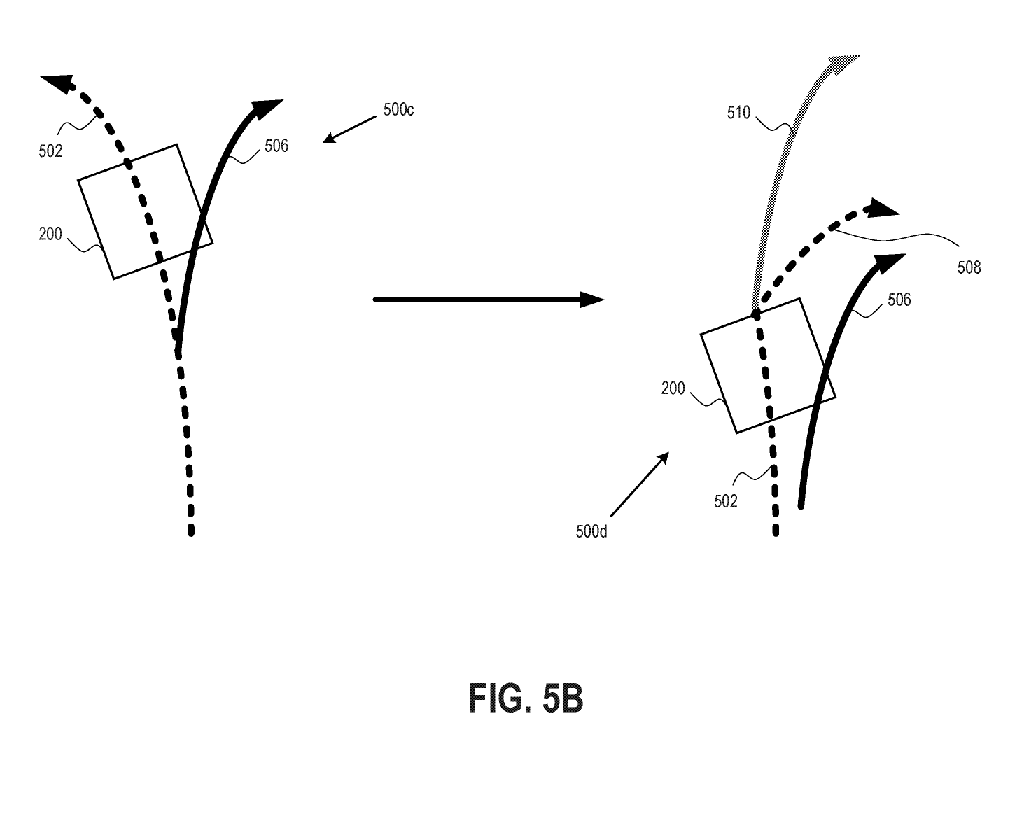

Turning to FIGS. 5A and 5B (collectively, “FIG. 5”), FIG. 5 depicts a diagram of navigation of a vehicle 200 along a path. Specifically, as can be seen at 500a, the vehicle 200 is currently traversing current path 502. Subsequently, as can be seen at 500b, the vehicle receives a command to traverse new path 506. The new path 506 can be based on, for example, an updated user preference, a change in path conditions, a teleoperation command, or some other reason or factor.

However, as described above and as shown at 500c, the updated control parameters related to the new path 506 will take a finite amount of time to be generated by the control system 408. As such, the vehicle 200 will continue along its previous path, path 502, during the generation of the updated control parameters.

500d depicts an example of time delay compensation related to the situation depicted in 500a-500c. Specifically, an intended new path 506 is depicted. However, as can be seen, and as was discussed with reference to 500c, the vehicle 200 had already moved along previous path 502 while control parameters related to new path 506 were calculated. Therefore, if the vehicle 200 enacted the control parameters related to new path 506, then the vehicle 200 would traverse path 510 as shown at 500d. However, in accordance with embodiments herein, the DBW system 202h of the vehicle 200, is configured to receive the control parameters from the control system 408 of the vehicle 200 and compensate for the delay that would ordinarily result in the vehicle 200 traversing path 510. This compensation technique results in the vehicle 200 traversing path 508 rather than path 510, as described with respect to embodiments disclosed herein.

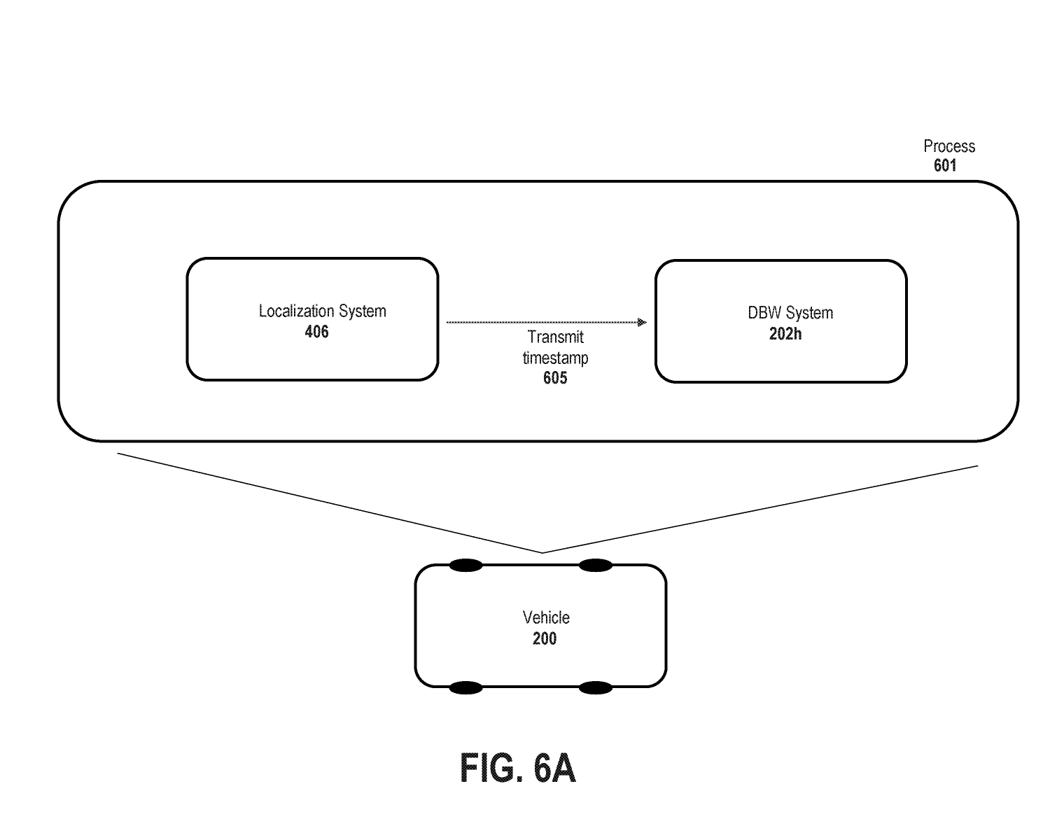

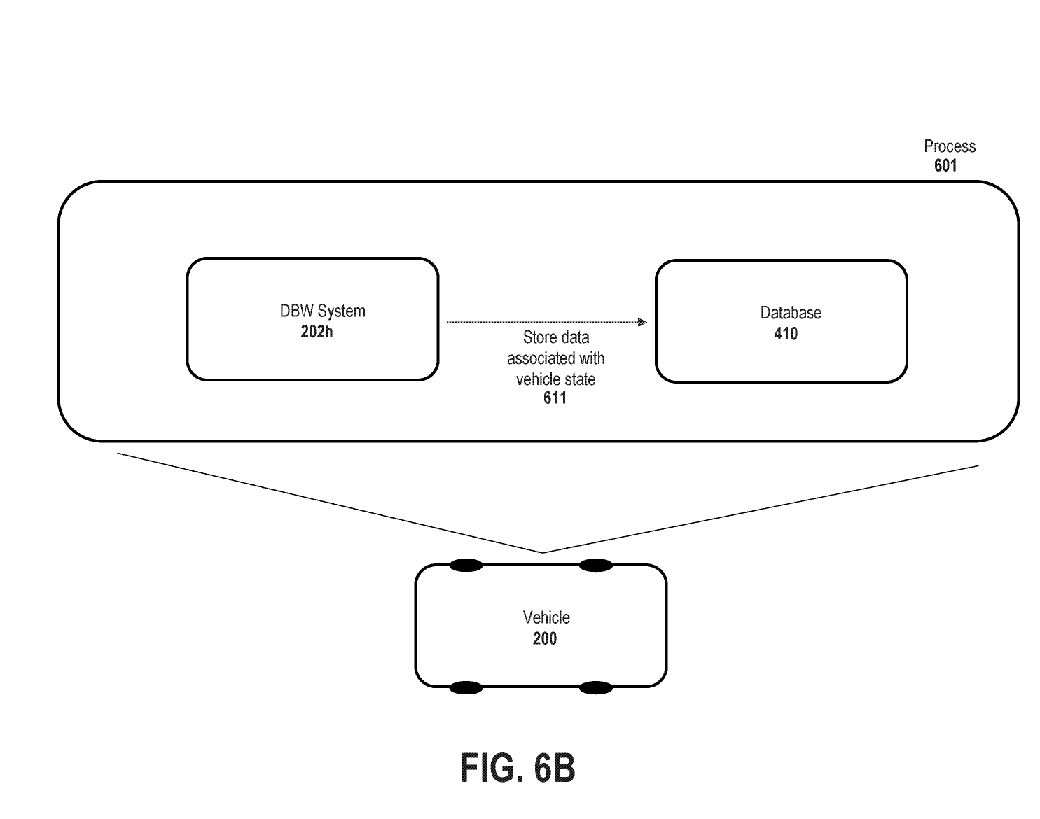

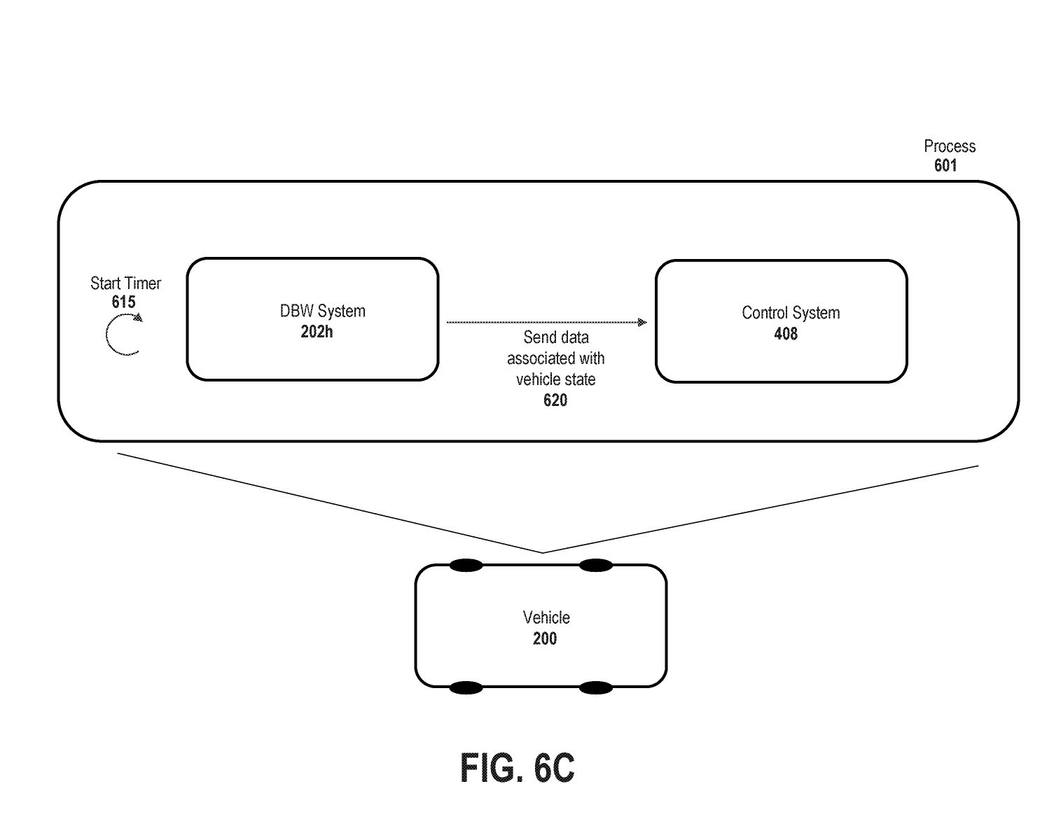

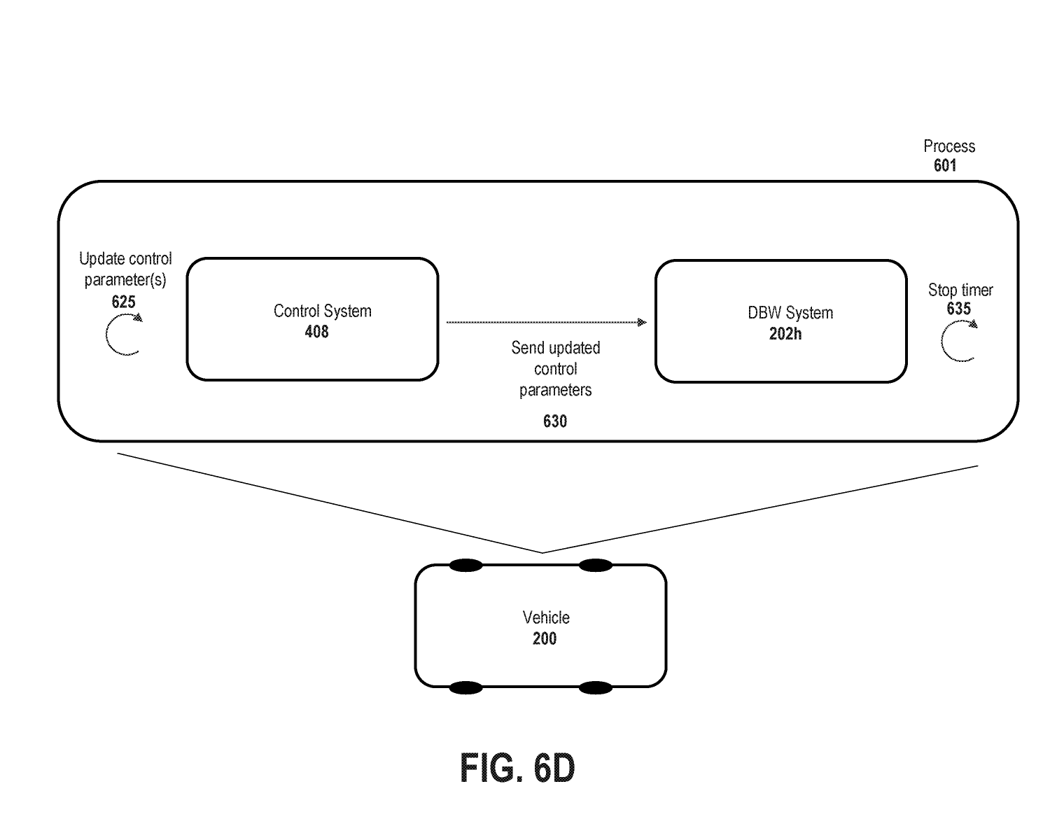

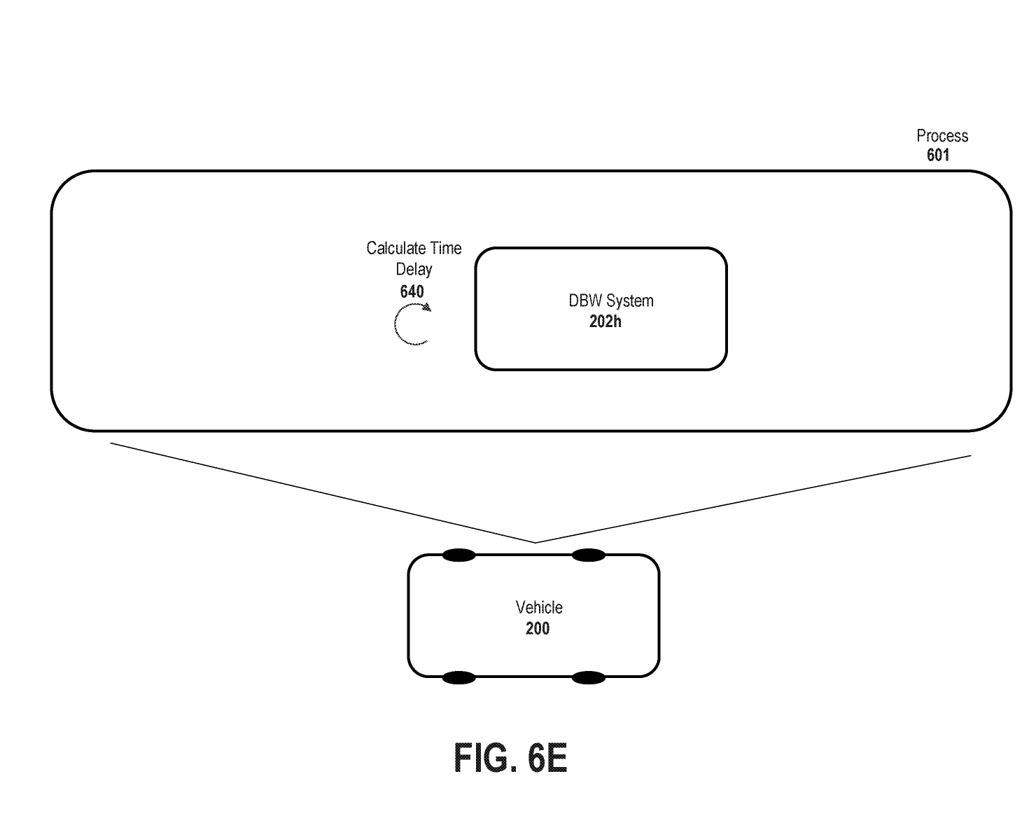

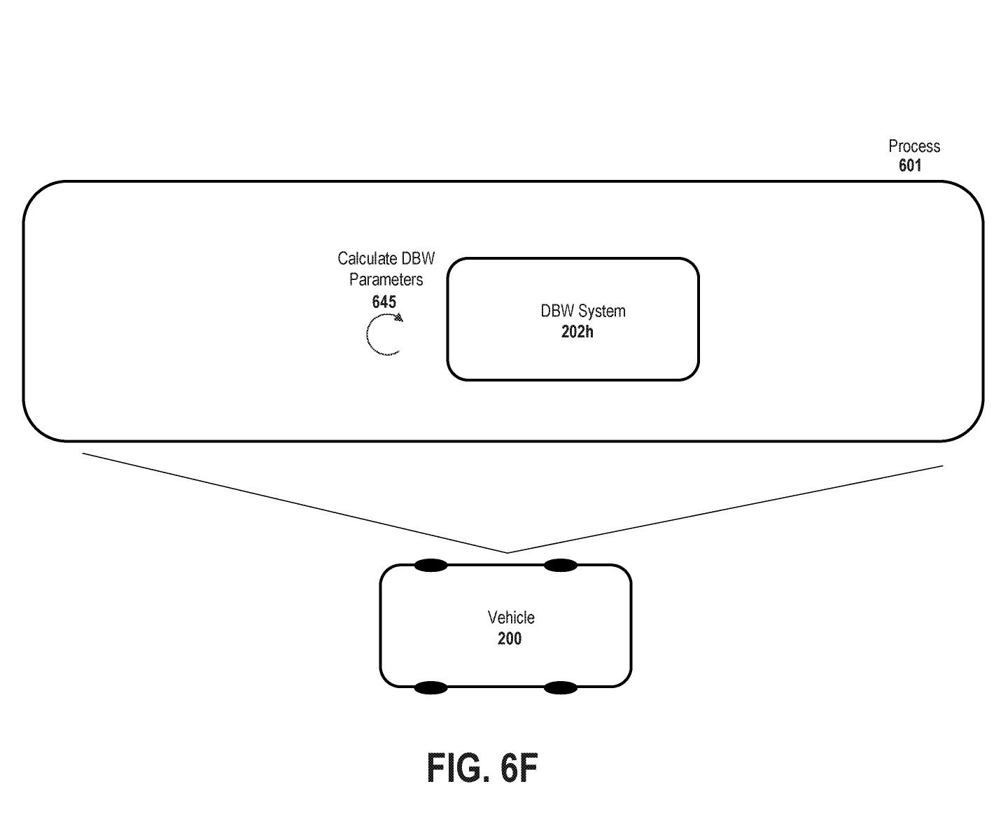

FIGS. 6A–6F are diagrams of an implementation of a process 601 for vehicle control time delay compensation. In some embodiments, the process 601 includes elements of vehicle 200 such as, for example, DBW system 202h, and/or elements of the autonomous vehicle compute 400 such as localization system 406, control system 408, and database 410.

With reference to FIG. 6A, the process 601 involves transmission of a timestamp at 605. For example, the timestamp may be transmitted by localization system 406 to DBW system 202h. The timestamp is, for example, related to a timestamp provided by a Global Navigation Satellite System (GNSS) (e.g., GPS) that can be used by the DBW system 202h for time synchronization. In an embodiment the timestamp is transmitted in response to a request by the DBW system 202h. For example, the DBW system 202h requests a timestamp if it had received a notification from control system 408 that updated control parameters were available. The timestamp data is transmitted periodically, and the DBW system synchronizes as soon as the data is received. In another embodiment, the localization system 406 can transmit the timestamp periodically. In other embodiments, the timestamp is transmitted in accordance with one or more other static or dynamic factors. For example, timestamp transmission can be triggered by polling or according to a pre-determined periodic schedule.

With reference to FIG. 6B, the process 601 further includes storing, by the DBW system 202h and database 410, data associated with the vehicle state at 611. The data associated with the vehicle state can include, for example data associated with the longitudinal velocity of the vehicle, data associated with the lateral velocity of the vehicle, data associated with an angular velocity of the vehicle, or some other data. In an embodiment, the vehicle state data may further include higher order vehicle state data, such as data associated with the overall velocity of the vehicle, which could be based on both the longitudinal velocity and the lateral velocity of the vehicle.

With reference to FIG. 6C, the process 601 further includes starting a timer at 615 by DBW system 202h. The process 601 further includes sending, at 620 by the DBW system 202h, the data associated with the vehicle state to the control system 408. Generally, the initial time associated with the timer at 615 is based on the timestamp received at 605. In an embodiment, starting the timer at 615 involves identifying a timestamp at which the data associated with the vehicle state is sent by the DBW system 202h to the control system 408 at 620. In another embodiment, starting the timer at 615 involves starting a timer that increments from a timestamp that is based on the synchronization time received at 605. In other embodiments, some other type of timekeeping or time tracking mechanism is used.

With reference to FIG. 6D, the process 601 further includes updating, at 625 by control system 408, one or more the control parameters. The updated control parameters can be similar to, for example, the updated control parameters described above with reference to FIG. 5. The control system 408 then sends, at 630, the updated control parameters to the DBW system 202h. The DBW system 202h then stops the timer at 635. In one embodiment, and as described above, stopping the timer at 635 can include identifying a timestamp at which the updated control parameters were received by the DBW system 202h. In another embodiment, stopping the timer at 635 can include identifying a timestamp at which the updated control parameters were transmitted by the control system 408 to the DBW system 202h. In another embodiment, stopping the timer at 635 can include stopping a timer that is running and monitored by the DBW system 202h. Other embodiments can include additional or alternative timers, or techniques by which a timer can be monitored by the DBW system 202h.

With reference to FIG. 6E, the DBW system 202h then calculates the time delay at 640. Specifically, the time delay calculated at 640 describes the time between which the DBW system 202h sent the vehicle state data to the control system 408 at 620, and the time at which the DBW system 202h received the updated control parameters at 630. In an embodiment, the time delay is based on the difference between the first timestamp described above with respect to 615, and the second timestamp described above with respect to 635. In another embodiment, the time delay is based on a timer that is run, and monitored by, the DBW system 202h.

With reference to FIG. 6F, the process 601 further includes calculating, at 645 by DBW system 202h, one or more DBW parameters. Specifically, the one or more DBW parameters are based on the updated control parameters received at 630. The one or more DBW parameters are further based on the time delay calculated at 640. In one embodiment, the DBW parameters are further based on information such as the vehicle state. More specifically, the vehicle state data, which may be considered historical information, can influence the DBW parameters by defining limits to the DBW parameters, or in some other way.

By identifying the time delay, control parameters, and/or vehicle state, the DBW system 202h is able to compensate for the time delay calculated at 640. More specifically, the DBW system 202h takes into account the time delay when calculating one or more DBW parameters based on the updated control parameters. In this way, the DBW system 202h is able to cause the vehicle 202 to traverse path 508, rather than, for example, path 510. For example, in one embodiment, one or more of the time delay, vehicle state, and updated control parameters can be used to calculate a lateral error and or heading error that can be used to adjust navigation of the vehicle to compensate for the time delay. In examples, the DBW system uses the historical vehicle state data (i.e. longitudinal/lateral velocity, and yaw rate) to compute a distance traveled during the time delay. The lateral error and heading error calculation can be corrected by this distance traveled. As a result, the navigation of the vehicle is adjusted to follow the intended path. In another example, the DBW system uses the historical vehicle state data and calculate the solution of following problem. If the control parameter is received with no time delay, given that the vehicle has travelled a longitudinal and lateral distance with a heading angle change during the delayed time duration, the DBW system uses historical vehicle state data to calculate the vehicle location along the path, for example, path 506. Accordingly, in some embodiments the distance traveled along path 502 is calculated and converted to the longitudinal/lateral/heading offset on path 506 (e.g., integrate historical vehicle state data along path 502 and execute a coordinate transform to path 506). In other embodiments, the historical vehicle state data is used directly to simulate how vehicle has already traveled on path 506 (e.g., directly integrate historical vehicle state data along path 506).

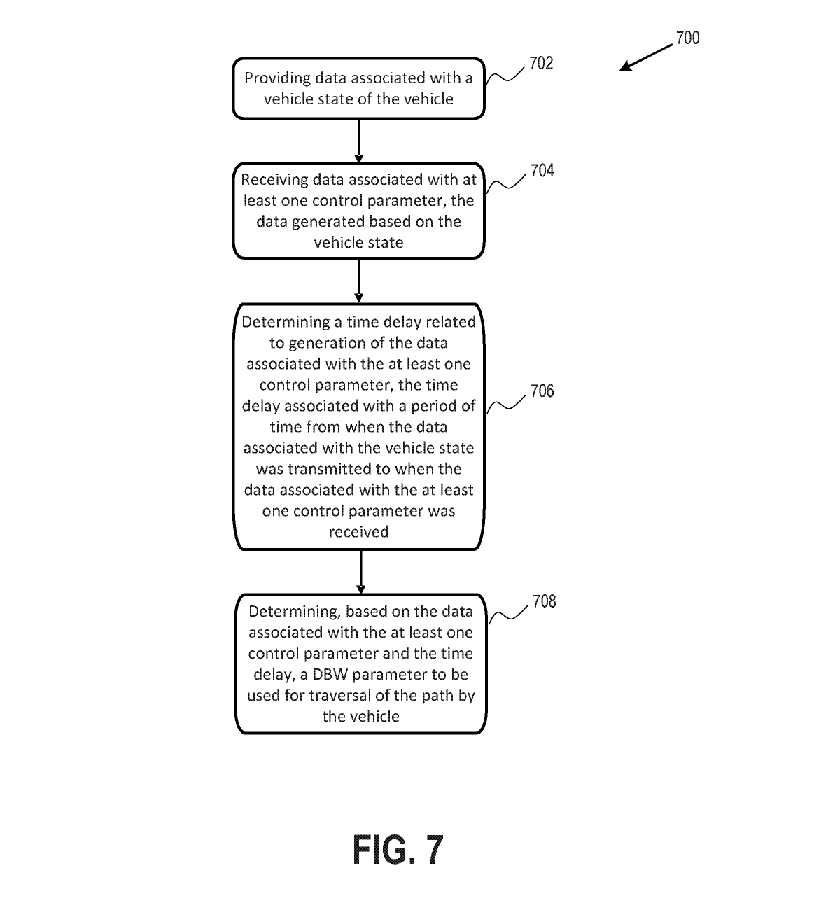

Turning to FIG. 7, a flowchart of a process 700 for vehicle control time delay compensation is shown. In embodiments, the process 700 is performed by, for example, DBW system 202h. In other embodiments, the process 700, or elements thereof, are additionally or alternatively performed by one or more other systems of vehicle 200 such as control system 408, planning system 404, or some other system.

The process 700 includes providing, at 702, data associated with the vehicle state of vehicle 200. For example, the DBW system 202h provides the vehicle state data to one or both of the control system 408 and database 410. As previously noted, the data associated with the vehicle state can include data associated with the longitudinal velocity of the vehicle, data associated with the lateral velocity of the vehicle, data associated with an angular velocity of the vehicle, and/or some other type of data.

The process 700 further includes receiving, at 704, data associated with at least one control parameter. For example, the data associated with the at least one control parameter is received by the DBW system 202h from the control system 408. In an embodiment, the data associated with the at least one control parameter is generated by the control system 408 based on the vehicle state. In an embodiment, the data associated with the at least one control parameter includes data related to control of the DBW system 202h. Specifically, the data associated with the at least one control parameter is related to updated control parameters described above.

The process 700 further includes determining, at 706, a time delay related to generation of the data associated with the at least one control parameter. Element 706 is performed, for example, by DBW system 202h. In another embodiment, the determination of the time delay can additionally or alternatively be performed by control system 408, and then an indication of the determined time delay is indicated to the DBW system 202h. As noted above, the time delay is associated with the calculation of the updated control parameters. In one embodiment, the time delay is a period of time from when the data associated with the vehicle state was transmitted at 702 to when the data associated with the at least one control parameter was received at 704. As noted above with respect to, for example, element 640, the time delay can be based on a timer, a difference between two timestamps, or some other factor. In an embodiment, if the time delay is based on the difference between two timestamps, the first timestamp may be the time at which the data was transmitted by the DBW system 202h, or a time at which the vehicle state data was received by control system 408. Similarly, the second timestamp may be the time at which the updated control parameter is transmitted by the control system 408, or the time at which the DBW system 202h receives the updated control parameter. Other variations may be present in other embodiments.

The process 700 further includes determining, by the DBW system 202h at 708 based on the data associated with the at least one control parameter and the time delay, a DBW parameter that is to be used for traversal of the path by the vehicle. In an embodiment, determination of the DBW parameter includes compensating for a distance traveled by the vehicle 200 along previous path such as path 502 during the time delay, as described above. In one embodiment, determination of the DBW parameter is further based on the vehicle state information as described above. The DBW parameter can be or include one or more of a steering parameter, a powertrain parameter, a braking parameter, or some other parameter. In embodiments, the delay is measured by the DBW system, and the DBW system computes the offset caused by time delay. The DBW parameters are based on this offset. To be specific, during the time delay, there is a distance traveled by the vehicle. This distance traveled causes an offset in the lateral error and heading error. By using historical vehicle state data saved internally in DBW, DBW system can compute this distance traveled, and can also compute the lateral error offset and heading error offset.

It will be understood that the above process 700 is intended as an example process for time delay compensation, and other embodiments will vary. For example, certain elements may be performed in an order different than depicted, concurrently with one another, or in some other order different than that depicted is described with respect process 700. Other variations are present in other embodiments.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system comprising:
at least one processor configured to implement a control system and a drive-by-wire (DBW) system of a vehicle; and
at least one non-transitory computer-readable media comprising instructions that, upon execution of the instructions by the at least one processor, are to cause the system to perform operations comprising:
determining, by the DBW system, a time delay related to generation of data associated with at least one control parameter by the control system, the generation based on a vehicle state provided by the DBW system, the time delay associated with a period of time beginning when the data associated with the vehicle state is transmitted to the control system from the DBW system according to a first Global Positioning System (GPS) timestamp and ending when the data associated with the at least one control parameter is received by the DBW system from the control system according to a second GPS timestamp, wherein the time delay is a difference between the first GPS timestamp and the second GPS timestamp;
determining, by the DBW system, a DBW parameter based on the data associated with the at least one control parameter and the time delay; and
causing the vehicle to traverse at least a portion of a path based on the DBW parameter.

2. The system of claim 1, wherein determining the DBW parameter comprises:
calculating a distance traveled by the vehicle along a previous path based on historical vehicle state data;
converting the distance traveled to an offset along the previous path; and
calculating the DBW parameter based on the offsetcompensating.

3. The system of claim 1, wherein determining the DBW parameter comprises:
determining a lateral error or heading error based on information related to the vehicle state;
computing a distance traveled based on the lateral error or heading error; and
determining the DBW parameter based on the distance traveled.

4. The system of claim 1, wherein the vehicle state comprises a longitudinal velocity of the vehicle.

5. The system of claim 1, wherein the vehicle state comprises a lateral velocity of the vehicle.

6. The system of claim 1, wherein the vehicle state comprises an angular velocity of the vehicle.

7. The system of claim 1, wherein the data associated with the at least one control parameter includes data related to control of the DBW system.

8. The system of claim 1, wherein the DBW parameter is a steering parameter, a powertrain parameter, or a braking parameter.

9. The system of claim 1, wherein the control system identifies control parameters associated with traversal of a path that an autonomous vehicle is to take, and the DBW system causes the vehicle to traverse the path in accordance with the control parameters.

10. A method comprising:
determining, by the DBW system, a time delay related to generation of data associated with at least one control parameter by the control system, the generation based on a vehicle state provided by the DBW system, the time delay associated with a period of time beginning when the data associated with the vehicle state is transmitted to the control system from the DBW system according to a first Global Positioning System (GPS) timestamp and ending when the data associated with at least one control parameter is received by the DBW system from the control system according to a second GPS timestamp, wherein the time delay is a difference between the first GPS timestamp and the second GPS timestamp;
determining, by the DBW system, a DBW parameter based on the data associated with at least one control parameter and the time delay; and
causing the vehicle to traverse at least a portion of a path based on the DBW parameter.

11. The method of claim 10, wherein determining the DBW parameter comprises:
calculating a distance traveled by the vehicle along a previous path based on historical vehicle state data;
converting the distance traveled to an offset along the previous path; and
calculating the DBW parameter based on the offset.

12. The method of claim 10, wherein determining the DBW parameter comprises:
determining a lateral error or heading error based on information related to the vehicle state;
computing a distance traveled based on the lateral error or heading error; and
determining the DBW parameter based on the distance traveled.

13. The method of claim 10, wherein the vehicle state comprises a longitudinal velocity of the vehicle.

14. The method of claim 10, wherein the vehicle state comprises a lateral velocity of the vehicle.

15. The method of claim 10, wherein the vehicle state comprises an angular velocity of the vehicle.

16. The method of claim 10, wherein the data associated with the at least one control parameter includes data related to control of the DBW system.

17. The method of claim 10, wherein the DBW parameter is a steering parameter, a powertrain parameter, or a braking parameter.

18. A method comprising:
determining, by the DBW system, a time delay related to generation of data associated with at least one control parameter by the control system, the generation based on a vehicle state provided by the DBW system, the time delay associated with a period of time beginning when the data associated with the vehicle state is transmitted to the control system from the DBW system according to a first Global Positioning System (GPS) timestamp and ending when the data associated with at least one control parameter is received from by the DBW system from the control system according to a first Global Positioning System (GPS) timestamp;
determining, using the at least one processor, a DBW parameter based on the data associated with at least one control parameter and the time delay; and
causing the vehicle to traverse at least a portion of a path based on the DBW parameter.

19. The method of claim 18, wherein determining the DBW parameter comprises:
calculating a distance traveled by the vehicle along a previous path based on historical vehicle state data;
converting the distance traveled to an offset along the previous path; and
calculating the DBW parameter based on the offset.
